(19) United States
(12) Patent Application Publication
(10) Pub. No.: US 2011/0149547 A1
(43) Pub. Date: Jun. 23, 2011

(54) OPTICAL ELEMENT AND COLOR COMBINER

(76) Inventors: Charles L. Bruzzone, Woodbury, MN (US); Andrew J. Ouderkirk, Singapore (SG); Daniel J. Kingston, Mendola Heights, MN (US)

(21) Appl. No.: 12/991,934

(22) PCT Filed: Dec. 18, 2008
(86) PCT No.: PCT/US08/87369

§ 371 Date: Jan. 31, 2011

Related U.S. Application Data
(60) Provisional application No. 61/053,270, filed on May 15, 2008.
(60) Provisional application No. 61/095,138, filed on Sep. 8, 2008.

(51) Int. Cl. G02B 27/10; G02B 27/28; F21V 9/14

(52) U.S. Cl. 362/19; 359/485.01; 359/485.03

(57) ABSTRACT

Optical elements, color combiners using the optical elements, and image projectors using the color combiners are described. The optical element includes color selective dichroic filters and a reflective polarizer. A line passing perpendicularly through each of the color selective dichroic filters intercepts the reflective polarizer at approximately 45 degrees. The optical element can also include retarders positioned adjacent to the color selective dichroic filters. The color combiner includes partially reflective light sources coupled to the optical element. Unpolarized light having different colors can enter the color combiner through the dichroic filters, and combined light of a desired polarization state can exit the color combiner. Light having an undesired polarization state can be recycled to the desired polarization state within the color combiner, so that light utilization efficiency is increased. The image projector includes a color combiner coupled to an imaging source and projection elements, so that a first portion of the combined light is directed to the projection element, and a second portion of the combined light is recycled back into the color combiner.

### BACKGROUND

Projection systems used for projecting an image on a screen can use multiple color light sources, such as light emitting diodes (LED's), with different colors to generate the illumination light. Several optical elements are disposed between the LED's and the image display unit to combine and transfer the light from the LED's to the image display unit. The image display unit can use various methods to impose an image on the light. For example, the image display unit may use polarization, as with transmissive or reflective liquid crystal displays.

Image brightness is an important parameter of a projection system. The brightness of color light sources and the efficiencies of collecting, combining, homogenizing and delivering the light to the image display unit all affect brightness. As the size of modern projector systems decreases, there is a need to maintain an adequate level of output brightness while at the same time keeping heat produced by the color light sources at a low level that can be dissipated in a small projector system. There is a need for a light combining system that combines multiple color lights with increased efficiency to provide a light output with an adequate level of brightness without excessive power consumption by light sources. There is also a need for a light combining system that directs light of different wavelength spectrums in a manner to minimize the degradation of the wavelength-sensitive components in the light combiner.

### SUMMARY

Generally, the present description relates to optical elements, color combiners using the optical elements, and image projectors using the color combiners. In one aspect, an optical element includes a first color selective dichroic filter, a second color selective dichroic filter, and a reflective polarizer. The dichroic filters and reflective polarizer are arranged so that a first and a second line passing perpendicularly through each of the first and second color selective dichroic filters, respectively, intercepts the reflective polarizer at approximately 45 degrees. In one embodiment, the optical element further comprises a reflector arranged so that a line perpendicular to the reflector also intercepts the reflective polarizer at approximately 45 degrees. In another embodiment, the reflective polarizer is selected from a cholesteric reflective polarizer and a MacNeille reflective polarizer. In yet another embodiment, the reflective polarizer is disposed between a first and second prism, so that each of the first and second color selective dichroic filters is disposed adjacent a prism face.

In yet another embodiment, the reflective polarizer is a Cartesian reflective polarizer aligned to a first polarization direction, and the optical element further includes a first and second retarder disposed so that the first and second lines pass perpendicularly through the first and second retarders, respectively, prior to intercepting the reflective polarizer. In one embodiment, each of the first and second retarders are aligned at 45 degrees to the first polarization direction.

In one aspect, an optical element includes a first color selective dichroic filter, a second color selective dichroic filter, and a reflective polarizer. The dichroic filters and reflective polarizer are arranged so that a first and a second line passing perpendicularly through each of the first and second color selective dichroic filters, respectively, intercepts the reflective polarizer at approximately 45 degrees. In one embodiment, the optical element further comprises a third dichroic filter arranged so that a line perpendicular to the third dichroic filter intercepts the reflective polarizer at approximately 45 degrees. In another embodiment, the reflective polarizer is a cholesteric reflective polarizer. In yet another embodiment, the reflective polarizer is a MacNeille reflective polarizer. In yet another embodiment, the reflective polarizer is disposed between a first and second prism, so that each of the first and second color selective dichroic filters is disposed adjacent a prism face.

In yet another embodiment, the reflective polarizer is a Cartesian reflective polarizer aligned to a first polarization direction, and the optical element further includes a first, second, and third retarder disposed so that the first, second, and third lines pass perpendicularly through the first, second and third retarders, respectively, prior to intercepting the reflective polarizer. In one embodiment, each of the first, second, and third retarders is aligned at 45 degrees to the first polarization direction.

In one aspect, a color combiner includes an optical element, light sources disposed to emit light toward each of the dichroic filters, and an output region disposed to transmit a combined color light output. In one embodiment, the light sources include a light emitting diode (LED). In another embodiment, each of the LEDs includes reflective surfaces. In yet another embodiment, the combined color light output is polarized.

In one aspect, an image projector includes a color combiner and an imager disposed to direct a first portion of the combined color light output to a projection element. In one embodiment, a second portion of the combined color light output is recycled back to the color combiner through the output region. In another embodiment, the imager is selected from an LCOS imager, a micrormirror array, and a transmissive LCD imager.

### BRIEF DESCRIPTION OF THE DRAWINGS

Throughout the specification reference is made to the appended drawings, where like reference numerals designate like elements, and wherein:

FIG. 1 is a perspective view of a polarizing beam splitter.

FIG. 2 is a perspective view of a polarizing beam splitter with a quarter-wave retarder.

FIG. 3a is a top schematic view showing a polarizing beam splitter with polished faces.

FIG. 3b is a top schematic view of an optical element and collimating lightguides.

FIGS. 4a-4c are top schematic views of a color combiner.

FIG. 5 is a schematic view of a projector.

FIGS. 6a-6b are top schematic views of a color combiner.

FIGS. 7a-7c are top schematic views of a color combiner.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The optical elements described herein can be configured as color combiners that receive different wavelength spectrum lights and produce a combined light output that includes the different wavelength spectrum lights. In one aspect, the received light inputs are unpolarized, and the combined light output is unpolarized. In one embodiment, a portion of the combined light output can be recycled back into the color combiner. In one aspect, the received light inputs are unpolarized, and the combined light output is polarized in a desired direction. In one embodiment, received lights with the undesired polarization direction are recycled and rotated to the desired polarization direction, improving the light utilization efficiency. In some embodiments, the combined light has the same etendue as each of the received lights. The combined light can be a polychromatic combined light that comprises more than one wavelength spectrum of light. The combined light can be a time sequenced output of each of the received lights. In one aspect, each of the different wavelength spectrums of light correspond to a different color light (e.g. red, green and blue), and the combined light output is white light, or a time sequenced red, green and blue light. For purposes of the description provided herein, “color light” and “wavelength spectrum light” are both intended to mean light having a wavelength spectrum range which may be correlated to a specific color if visible to the human eye. The more general term “wavelength spectrum light” refers to both visible and other wavelength spectrums of light including, for example, infrared light.

Also for the purposes of the description provided herein, the term “facing” refers to one element disposed so that a perpendicular line from the surface of the element follows an optical path that is also perpendicular to the other element. One element facing another element can include the elements disposed adjacent each other. One element facing another element further includes the elements separated by optics so that a light ray perpendicular to one element is also perpendicular to the other element.

When two or more unpolarized color lights are directed to the optical element, each is split according to polarization by a reflective polarizer. According to one embodiment described below, a color light combining system receives unpolarized light from different color unpolarized light sources, and produces a combined light output that is polarized in one desired direction. In one aspect, up to three received color lights are each split according to polarization (e.g. s-polarization and p-polarization, or right and left circular polarization) by a reflective polarizer in a polarizing beam splitter (PBS). The received light of one polarization direction is recycled to become the desired polarization direction.

According to one aspect, the PBS comprises a reflective polarizer positioned so that light from each of the three color lights intercept the reflective polarizer at approximately a 45 degree angle. The reflective polarizer can be any known reflective polarizer such as a MacNeille polarizer, a wire grid polarizer, a multilayer optical film polarizer, or a circular polarizer such as a cholesteric liquid crystal polarizer. According to one embodiment, a multilayer optical film polarizer can be a preferred reflective polarizer. The reflective polarizer can be disposed between the diagonal faces of two prisms, or it can be a free-standing film such as a pellicle. In some embodiments, the PBS light utilization efficiency is improved when the reflective polarizer is disposed between two prisms. In this embodiment, some of the light traveling through the PBS which would otherwise be lost from the optical path can undergo Total Internal Reflection (TIR) from the prism faces and rejoin the optical path. For at least this reason, the following description is directed to PBSs where reflective polarizers are disposed between the diagonal faces of two prisms; however, it is to be understood that the PBS can function in the same manner when used as a pellicle. In one aspect, all of the external faces of the PBS prisms are highly polished so that light entering the PBS undergoes TIR. In this manner, light is contained within the PBS and the light is partially homogenized while still preserving etendue.

According to one aspect, wavelength selective filters such as color selective dichroic filters, are placed in the path of input light from each of the different colored light sources. Each of the dichroic filters is positioned so that the input light intercepts the filter at near-normal incidence to minimize splitting of s- and p-polarized light, and also to minimize color shifting. Each of the dichroic filters is selected to transmit light having a wavelength spectrum of the adjacent input light source, and reflect light having a wavelength spectrum of at least one of the other input light sources. In some embodiments, each of the dichroic filters is selected to transmit light having a wavelength spectrum of the adjacent input light source, and reflect light having a wavelength spectrum of all of the other input light sources. In one aspect, each of the dichroic filters is positioned relative to the reflective polarizer so that a normal to the surface of each dichroic filter intersects the reflective polarizer at an intercept angle of approximately 45 degrees. By normal to the surface of a dichroic filter is meant a line passing perpendicularly to the surface the dichroic filter. In one embodiment, the intercept angle ranges from 35 to 55 degrees; from 40 to 50 degrees; from 43 to 48 degrees; or from 44.5 to 45.5 degrees.

In one aspect, input light of an undesired polarization direction is recycled by being directed back toward the light source, where it reflects from the surface, for example a partially reflective LED. In one embodiment, a retarder is disposed within the light path from each input light to the prism face, so that light from the light source passes through a dichroic filter and a retarder before entering the PBS prism face. Light having an undesired polarization direction is recycled back and reflected from the LED, and passes through the retarder twice, changing to the desired polarization direction.

In some embodiments, the retarder is placed between the dichroic filter and the light source. In other embodiments, the dichroic filter is placed between the retarder and the light source. The particular combination of dichroic filters, retarders, and source orientation all cooperate to enable a smaller, more compact, optical element that, when configured as a color combiner, efficiently produces combined light of a single polarization direction. According to one aspect, the retarder is a quarter-wave retarder aligned at approximately 45 degrees to a polarization direction of the reflective polarizer. In one embodiment, the alignment can be from 35 to 55 degrees; from 40 to 50 degrees; from 43 to 48 degrees; or from 44.5 to 45.5 degrees to a polarization direction of the reflective polarizer.

In one aspect, the first color light comprises a blue light, the second color light comprises a green light and the third color light comprises a red light, and the color light combiner combines the red light, blue light and green light to produce polarized white light. In one aspect, the first color light comprises a blue light, the second color light comprises a green light and the third color light comprises a red light, and the color light combiner combines the red, green and blue light to produce a time sequenced polarized red, green and blue light. In one aspect, each of the first, second and third color lights are disposed in separate light sources. In another aspect, more than one of the three color lights are combined into one of the sources.

According to one aspect, the reflective polarizing film comprises a multi-layer optical film. The PBS produces a first combined light output that includes p-polarized second color light, and s-polarized first and third color light. The first combined light output can be passed through a color-selective stacked retardation filter that selectively changes the polarization of the second color light as the second color light passes through the filter. Such color-selective stacked retardation filters are available from, for example, ColorLink Inc, Boulder, Col. The filter produces a second combined light output that includes the first, second and third color lights combined to have the same polarization (e.g. s-polarization). The second combined output is useful for illumination of transmissive or reflective display mechanisms that modulate polarized light to produce an image.

The light can be collimated, convergent, or divergent when it enters the PBS. Convergent or divergent light entering the PBS can be lost through one of the faces or ends of the PBS. To avoid such losses, all of the exterior faces of a prism based PBS can be polished to enable total internal reflection (TIR) within the PBS. Enabling TIR improves the utilization of light entering the PBS, so that substantially all of the light entering the PBS within a range of angles is redirected to exit the PBS through the desired face.

A polarization component of each color light can pass through to a polarization rotating reflector. The polarization rotating reflector reverses the propagation direction of the light and alters the magnitude of the polarization components, depending of the type and orientation of a retarder disposed in the polarization rotating reflector. The polarization rotating reflector can include a wavelength-selective mirror, such as a dichroic filter, and a retarder. The retarder can provide any desired retardation, such as an eighth-wave retarder, a quarter-wave retarder, and the like. In embodiments described herein, there is an advantage to using a quarter-wave retarder and an associated dichroic reflector. Linearly polarized light is changed to circularly polarized light as it passes through a quarter-wave retarder aligned at an angle of 45° to the axis of light polarization. Subsequent reflections from the reflective polarizer and quarter-wave retarder/reflectors in the color combiner result in efficient combined light output from the color combiner. In contrast, linearly polarized light is changed to a polarization state partway between s-polarization and p-polarization (either elliptical or linear) as it passes through other retarders and orientations, and can result in a lower efficiency of the combiner.

The components of the optical element including prisms, reflective polarizers, quarter-wave retarders, mirrors, filters or other components can be bonded together by a suitable optical adhesive. The optical adhesive used to bond the components together has a lower index of refraction than the index of refraction of the prisms used in the optical element. An optical element that is fully bonded together offers advantages including alignment stability during assembly, handling and use.

The embodiments described above can be more readily understood by reference to the Figures and their accompanying description, which follows.

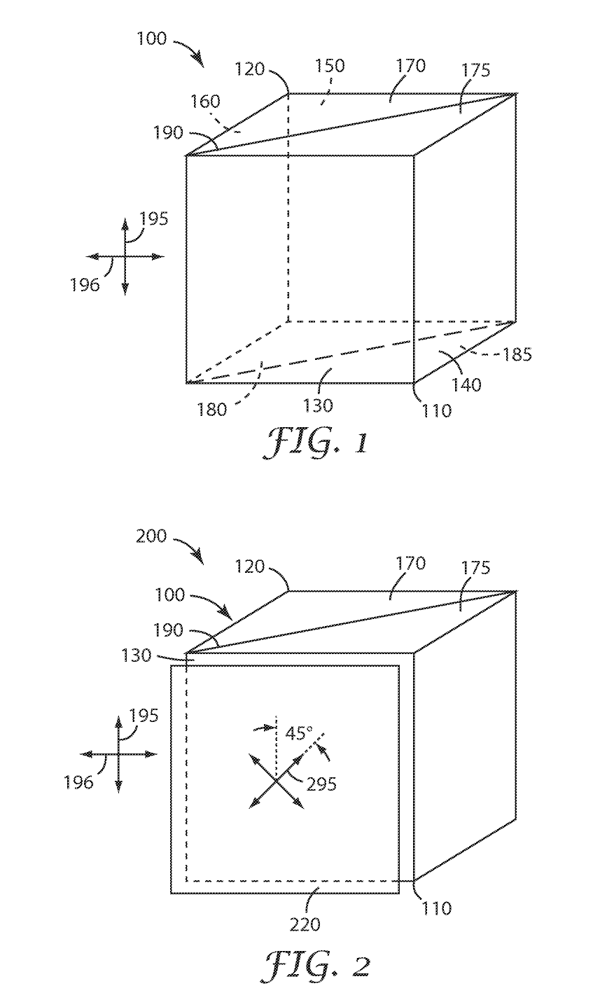

FIG. 1 is a perspective view of a PBS. PBS 100 includes a reflective polarizer 190 disposed between the diagonal faces of prisms 110 and 120. Prism 110 includes two end faces 175, 185, and a first and second prism face 130, 140 having a 90° angle between them. Prism 120 includes two end faces 170, 180, and a third and fourth prism face 150, 160 having a 90° angle between them. The first prism face 130 is parallel to the third prism face 150, and the second prism face 140 is parallel to the fourth prism face 160. The identification of the four prism faces shown in FIG. 1 with a “first”, “second”, “third” and “fourth” serves to clarify the description of PBS 100 in the discussion that follows. First reflective polarizer 190 can be a Cartesian reflective polarizer or a non-Cartesian reflective polarizer. A non-Cartesian reflective polarizer can include multilayer inorganic films such as those produced by sequential deposition of inorganic dielectrics, such as a MacNeille polarizer. A Cartesian reflective polarizer has a polarization axis direction, and includes both wire-grid polarizers and polymeric multilayer optical films such as can be produced by extrusion and subsequent stretching of a multilayer polymeric laminate. In one embodiment, reflective polarizer 190 is aligned so that one polarization axis is parallel to a first polarization direction 195, and perpendicular to a second polarization direction 196. In one embodiment, the first polarization direction 195 can be the s-polarization direction, and the second polarization direction 196 can be the p-polarization direction. As shown in FIG. 1, the first polarization direction 195 is perpendicular to each of the end faces 170, 175, 180, 185.

A Cartesian reflective polarizer film provides the polarizing beam splitter with an ability to pass input light rays that are not fully collimated, and that are divergent or skewed from a central light beam axis with high efficiency. The Cartesian reflective polarizer film can comprise a polymeric multilayer optical film that comprises multiple layers of dielectric or polymeric material. Use of dielectric films can have the advantage of low attenuation of light and high efficiency in passing light. The multilayer optical film can comprise polymeric multilayer optical films such as those described in U.S. Pat. No. 5,962,114 (Jonza et al.) or U.S. Pat. No. 6,721,096 (Bruzzone et al.).

FIG. 2 is a perspective view of the alignment of a quarter-wave retarder to a PBS, as used in some embodiments. Quarter-wave retarders can be used to change the polarization state of incident light. PBS retarder system 200 includes PBS 100 having first and second prisms 110 and 120. A quarter-wave retarder 220 is disposed adjacent the first prism face 130. Reflective polarizer 190 is a Cartesian reflective polarizer film aligned to first polarization direction 195. Quarter-wave retarder 220 includes a quarter-wave polarization direction 295 that can be aligned at 45° to first polarization direction 195. Although FIG. 2 shows polarization direction 295 aligned at 45° to first polarization direction 195 in a clockwise direction, polarization direction 295 can instead be aligned at 45° to first polarization direction 195 in a counterclockwise direction. In some embodiments, quarter-wave polarization direction 295 can be aligned at any degree orientation to first polarization direction 195, for example from 90° in a counter-clockwise direction to 90° in a clockwise direction. It can be advantageous to orient the retarder at approximately +/−45° as described, since circularly polarized light results when linearly polarized light passes through a quarter-wave retarder so aligned to the polarization direction. Other orientations of quarter-wave retarders can result in s-polarized light not being fully transformed to p-polarized light, and p-polarized light not being fully transformed to s-polarized light upon reflection from the mirrors, resulting in reduced efficiency of the optical elements described elsewhere in this description.

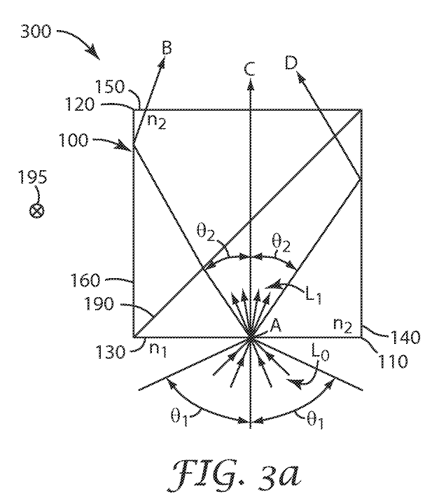

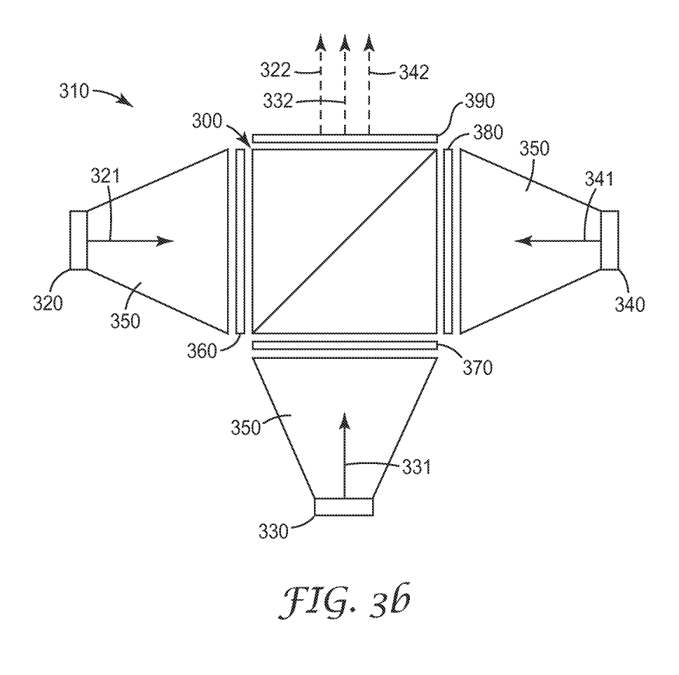

FIG. 3a shows a top view of a path of light rays within a polished PBS 300. According to one embodiment, the first, second, third and fourth prism faces 130, 140, 150, 160 of prisms 110 and 120 are polished external surfaces. According to another embodiment, all of the external faces of the PBS 300 (including end faces, not shown) are polished faces that provide TIR of oblique light rays within PBS 300. The polished external surfaces are in contact with a material having an index of refraction “n₁” that is less than the index of refraction “n₂” of prisms 110 and 120. TIR improves light utilization in PBS 300, particularly when the light directed into PBS is not collimated along a central axis, i.e. the incoming light is either convergent or divergent. At least some light is trapped in PBS 300 by total internal reflections until it leaves through third prism face 150. In some cases, substantially all of the light is trapped in PBS 300 by total internal reflections until it leaves through third prism face 150.

As shown in FIG. 3a, light rays Lₒ enter first prism face 130 within a range of angles θ₁. Light rays L₁ within PBS 300 propagate within a range of angles θ₂ such that the TIR condition is satisfied at prism faces 140, 160 and the end faces (not shown). Light rays “AB”, “AC” and “AD” represent three of the many paths of light through PBS 300, that intersect reflective polarizer 190 at different angles of incidence before exiting through third prism face 150. Light rays “AB” and “AD” also both undergo TIR at prism faces 140 and 160, respectively, before exiting. It is to be understood that ranges of angles θ₁ and θ₂ can be a cone of angles so that reflections can also occur at the end faces of PBS 300. In one embodiment, reflective polarizer 190 is selected to efficiently split light of different polarizations over a wide range of angles of incidence. A polymeric multilayer optical film is particularly well suited for splitting light over a wide range of angles of incidence. Other reflective polarizers including MacNeille polarizers and wire-grid polarizers can be used, but are less efficient at splitting the polarized light. A MacNeille polarizer does not efficiently transmit light at angles of incidence that differ substantially from the design angle, which is typically 45 degrees to the polarization selective surface, or normal to the input face of the PBS. Efficient splitting of polarized light using a MacNeille polarizer can be limited to incidence angles below about 6 or 7 degrees from the normal, since significant reflection of the p-polarization state can occur at some larger angles, and significant transmission of s-polarization state can also occur at some larger angles. Both effects can reduce the splitting efficiency of a MacNeille polarizer. Efficient splitting of polarized light using a wire-grid polarizer typically requires an air gap adjacent one side of the wires, and efficiency drops when a wire-grid polarizer is immersed in a higher index medium. A wire-grid polarizer used for splitting polarized light is shown, for example, in PCT publication WO 2008/1002541.

In one aspect, FIG. 3b shows an optical element 310 configured as a color combiner, comprising a light tunnel 350 disposed between each of a first, second and third light source (320, 330, 340) and a PBS 300. The light tunnels 350 can be useful to partially collimate light originating from the light source, and decrease the angle that the light enters the PBS. A first, second, and third light source 320, 330, 340 emits first, second, and third unpolarized color light 321, 331, 341 which travels through light tunnels 350, passes through a first, second, and third polarization rotating reflector 360, 370, 380 (respectively) into PBS 300, passes through color selective stacked retardation polarizer 390, and exits optical element 310 as first, second, and third color light 322, 332, 342 polarized in a first direction. Polarization rotating reflectors 360, 370, 380 will be described more fully elsewhere, but generally comprise a dichroic filter and retarder. The position of the retarder and dichroic filter relative to the adjacent light source is dependent on the desired path of each of the polarization components, and are described elsewhere with reference to the Figures. Light tunnels 350 are an optional component for the optical element 310, and are omitted from descriptions of the color combiner that follow. These light tunnels could have straight or curved sides, or they could be replaced by a lens system. Different approaches may be preferred depending on specific details of each application, and those with skill in the art will face no difficulty in selecting the optimal approach for a specific application.

In some embodiments, color selective stacked retardation polarizer 390 is optional, for example where rotation of the polarization direction of one or more of the color lights is not desired. In some embodiments, optical element 310 can be configured to combine unpolarized light sources into a combined unpolarized light, and color selective stacked retardation polarizer 390 is not required.

In one aspect, reflective polarizer 190 can be a circular polarizer such as a cholesteric liquid crystal polarizer. According to this aspect, polarization rotating reflectors 360, 370, 380 comprise dichroic filters without any associated retarders, and color selective stacked retardation polarizer 390 is omitted. In one embodiment, first, second, and third unpolarized color light 321, 331, 341 travels through light tunnels 350, passes through a first, second, and third polarization rotating reflector 360, 370, 380 (respectively) into PBS 300, and exits color combiner 310 as first, second, and third unpolarized (left- and right-circularly polarized) color light 322, 332, 342.

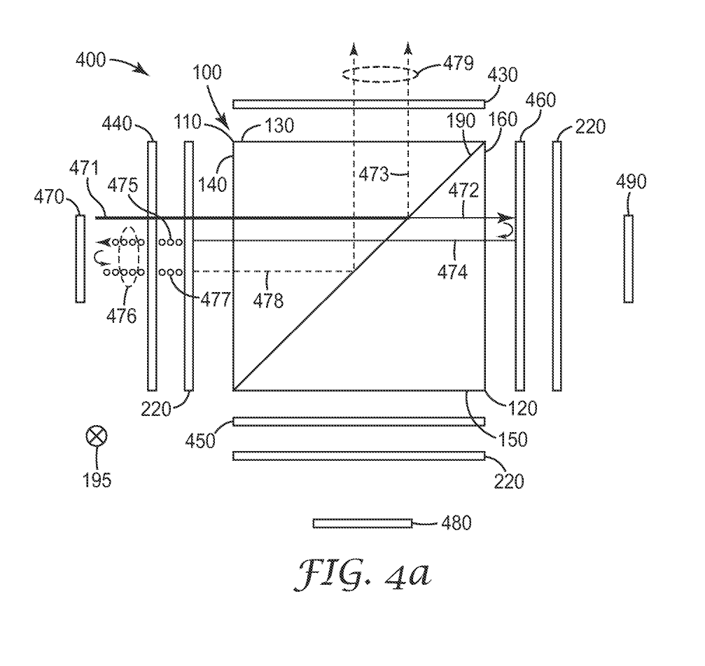

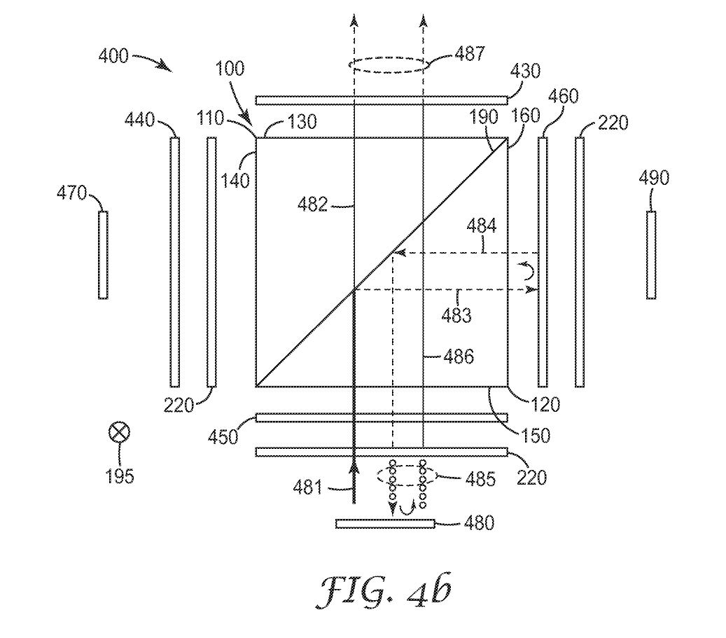

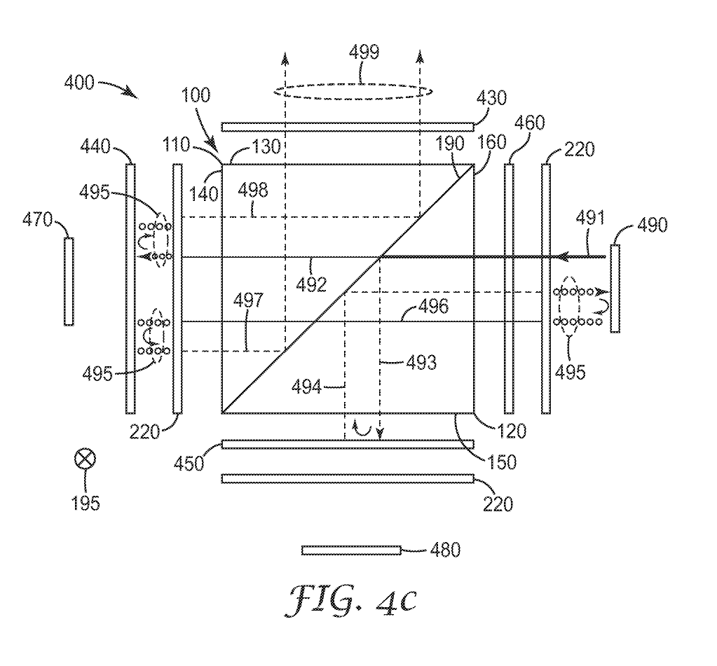

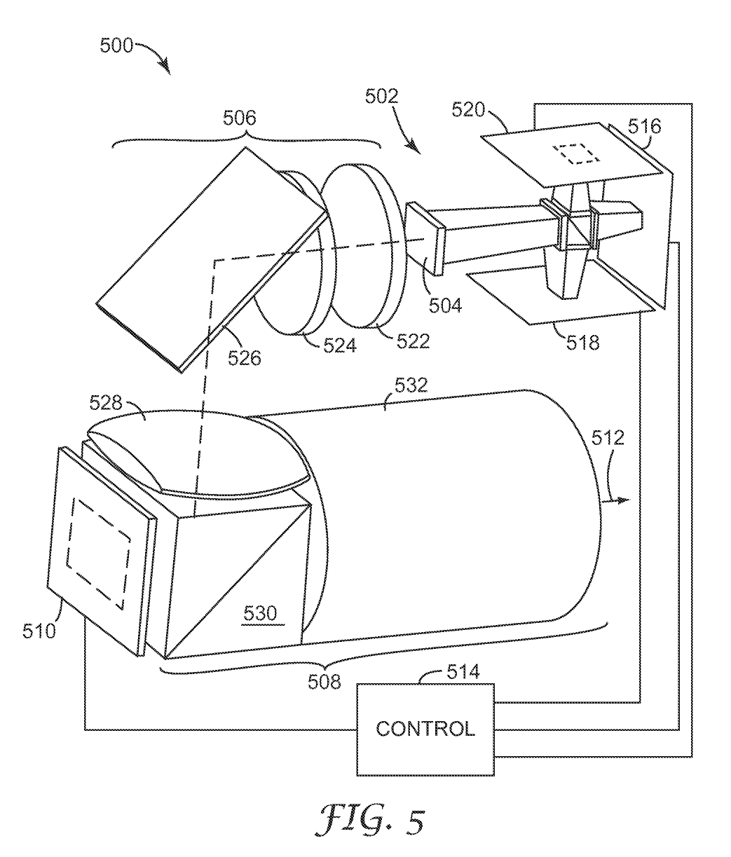

In one aspect, FIGS. 4a-4c are top view schematic representations of a color combiner 400 that includes a PBS 100. Color combiner 400 can be used with a variety of light sources as described elsewhere. The paths of light rays of each polarization emitted from a first, second, and third partially reflective light source 470, 480, 490 are shown in FIGS. 4a-4c, to more clearly illustrate the function of the various components of color combiner 400. PBS 100 includes a reflective polarizer 190 aligned to the first polarization direction 195 as described elsewhere. In one aspect, the reflective polarizer 190 can comprise a polymeric multilayer optical film. A first, second and third wavelength selective filter 440, 450, 460 is disposed facing the second, third and fourth prism faces 140, 150, 160, respectively. Each of the first, second and third wavelength selective filters 440, 450, 460 can be a dichroic filter selected to transmit a first, second and third wavelength spectrum of light and reflect other wavelength spectrums of light.

A retarder 220 is disposed facing each of the first, second and third wavelength selective filters 440, 450, 460. The retarder 220, wavelength selective filter (440, 450, 460), and partially reflective light source (470, 480, 490) cooperate to transmit one polarization direction of light, and recycle the other polarization state of light, as described elsewhere. In one embodiment, each retarder 220 in color combiner 400 is a quarter-wave retarder orientated at 45° to the first polarization direction 195.

Color combiner 400 also includes a filter 430 disposed facing the first prism face 130, the filter 430 capable of changing the polarization direction of at least one selected wavelength spectrum of light without changing the polarization direction of at least another selected wavelength spectrum of light. In one aspect, the filter 430 is a color-selective stacked retardation polarizer, such as a ColorSelect® filter (available from ColorLink® Inc., Boulder, Col.).

Each of the partially reflective light sources (470, 480, 490) has a surface that is at least partially light reflective. Each light source is mounted on a substrate that can also be at least partially reflective. The reflective light source, and optionally the reflective substrate cooperate with the color combiner to recycle light and improve efficiency. According to yet another aspect, light tunnels or collection lenses can be provided to provide spacing that separate light sources from the polarizing beam splitter, as described elsewhere. An integrator can be provided at the output of the color combiner to increase uniformity of combined light outputs. According to one aspect, each partially reflective light source (470, 480, 490) comprises one or more light emitting diodes (LED's). Various light sources can be used such as lasers, laser diodes, organic LED's (OLED's), and non solid state light sources such as ultra high pressure (UHP), halogen or xenon lamps with appropriate collectors or reflectors. Light sources, light tunnels, lenses, and light integrators useful in the present invention are further described, for example, in copending U.S. Patent Application Ser. No. 60/938,834, the disclosure of which is herein included in its entirety.

The path of a first color light 471 will now be described with reference to FIG. 4a, where unpolarized first color light 471 exits color combiner 400 as s-polarized first color light 479. First light source 470 injects unpolarized first color light 471 through first dichroic filter 440, retarder 220, enters PBS 100 through second prism face 140, intercepts reflective polarizer 190, and is split into p-polarized first color light 472 and s-polarized first color light 473. S-polarized first color light 473 reflects from reflective polarizer 190, exits PBS 100 through first prism face 130 and passes unchanged through filter 430, becoming s-polarized first color light 479.

P-polarized first color light 472 is transmitted through reflective polarizer 190, exits PBS 100 through fourth prism face 160, reflects from third dichroic filter 460, and re-enters PBS 100 through fourth prism face 160 as p-polarized first color light 474. P-polarized first color light 474 passes through reflective polarizer 190, exits PBS 100 through second prism face 140, and changes to first direction circular polarized first color light 475 as it passes through retarder 220. First direction circular polarized first color light 475 passes through first dichroic filter 440 becoming circular polarized light 476 which reflects from partially reflective first light source 470, changes direction of circular polarization, and passes through dichroic filter 440 as second direction circular polarized first color light 477. Second direction circular polarized first color light 477 passes through retarder 220 becoming s-polarized first color light 478 which enters PBS 100 through second face 140, reflects from reflective polarizer 190, exits PBS 100 through first prism face 130, and passes unchanged through filter 430, becoming s-polarized first color light 479.

The path of a second color light 481 will now be described with reference to FIG. 4b, where unpolarized second color light 481 exits color combiner 400 as s-polarized second color light 487. Second partially reflective light source 480 injects unpolarized second color light 481 through retarder 220 and second dichroic filter 450, enters PBS 100 through third prism face 150, intercepts reflective polarizer 190, and is split into p-polarized second color light 482 and s-polarized first color light 483. P-polarized second color light 482 passes unchanged through reflective polarizer 190, exits PBS 100 through first prism face 130 and passes through filter 430, changing polarization direction to become s-polarized second color light 487.

S-polarized second color light 483 reflects from reflective polarizer 190, exits PBS 100 through fourth prism face 160, reflects from third dichroic filter 460, and enters PBS 100 through fourth prism face 160 as s-polarized second color light 484. S-polarized second color light 484 reflects from reflective polarizer 190, exits PBS 100 through third prism face 150, passes through second dichroic filter 450, and changes to circular polarized second color light 485 as it passes through retarder 220. Circular polarized second color light 485 reflects from second partially reflective light source 480, changes direction of circular polarization, and passes through retarder 220, changing to p-polarized second color light 486. P-polarized second color light 486 passes through second dichroic filter 450, enters PBS 100 through third prism face 150, passes through reflective polarizer 190, exits PBS 100 through first prism face 130, and changes to s-polarized second color light 487 as it passes through filter 430.

The path of a third color light 491 will now be described with reference to FIG. 4c, where unpolarized third color light 491 exits color combiner 400 as s-polarized third color light 499. Third partially reflective light source 490 injects unpolarized third color light 491 through retarder 220 and third dichroic filter 460, enters PBS 100 through fourth prism face 160, intercepts reflective polarizer 190, and is split into p-polarized third color light 492 and s-polarized third color light 493. P-polarized third color light 492 passes through reflective polarizer 190, exits PBS 100 through second prism face 140 and changes to circular polarized second color light 495 as it passes through retarder 220. Circular polarized second color light 495 reflects from first dichroic filter 440 changing direction of circular polarization, and changes to s-polarized third color light 498 as it passes through retarder 220. S-polarized third color light 498 enters PBS 100 through second prism face 140, reflects from reflective polarizer 190, exits PBS 100 through first prism face 130 and passes unchanged through filter 430, becoming s-polarized third color light 499.

S-polarized third color light 493 reflects from reflective polarizer 190, exits PBS 100 through third prism face 150, reflects from second dichroic filter 450, and enters PBS 100 through third prism face 150 as s-polarized third color light 494. S-polarized third color light 494 reflects from reflective polarizer 190, exits PBS 100 through fourth prism face 160, passes through third dichroic filter 460, changes to circular polarized third color light 495 as it passes through retarder 220, reflects from third partially reflective light source 490 changing direction of circular polarization, and changes to p-polarized third color light 496 as it passes through retarder 220. P-polarized third color light 496 passes through third dichroic filter 460, enters PBS 100 through fourth prism face 160, passes through reflective polarizer 190, and exits PBS 100 through second prism face 140. P-polarized third color light 496 changes to circular polarized third color light 495 as it passes through retarder 220, reflects from first dichroic filter 440 changing direction of circular polarization, and changes to s-polarized third color light 497 as it passes through retarder 220. S-polarized third color light 497 enters PBS 100 through second prism face 140, reflects from reflective polarizer 190, exits PBS 100 through first prism face 130, and passes unchanged through filter 430 as s-polarized second color light 497.

In one embodiment, first color light 470 is blue light, second color light 480 is green light, and third color light 490 is red light. According to this embodiment, dichroic filter 440 is a red light reflecting and blue light transmitting dichroic filter, dichroic filter 450 is a red light reflecting and green light transmitting dichroic filter, and dichroic filter 460 is a green and blue light reflecting and red light transmitting dichroic filter. According to one embodiment, filter 430 is a GM ColorSelect® filter that changes the polarization direction of green light while allowing both red and blue light to be transmitted without change in polarization. According to another embodiment, filter 430 is an MG ColorSelect® filter that changes the polarization direction of red and blue light while allowing green light to be transmitted without change in polarization.

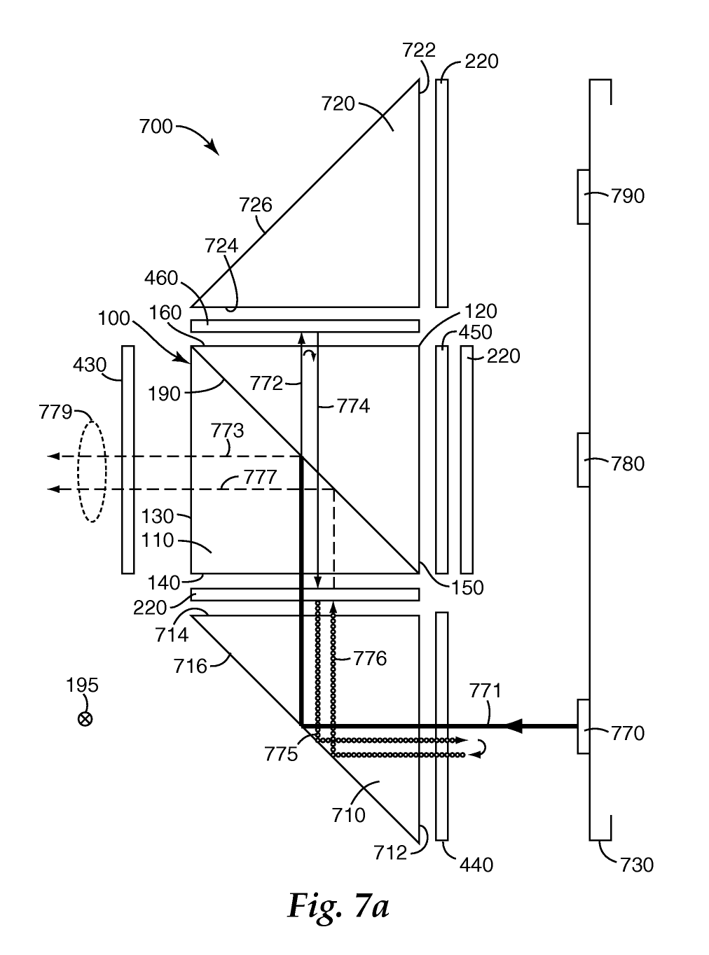

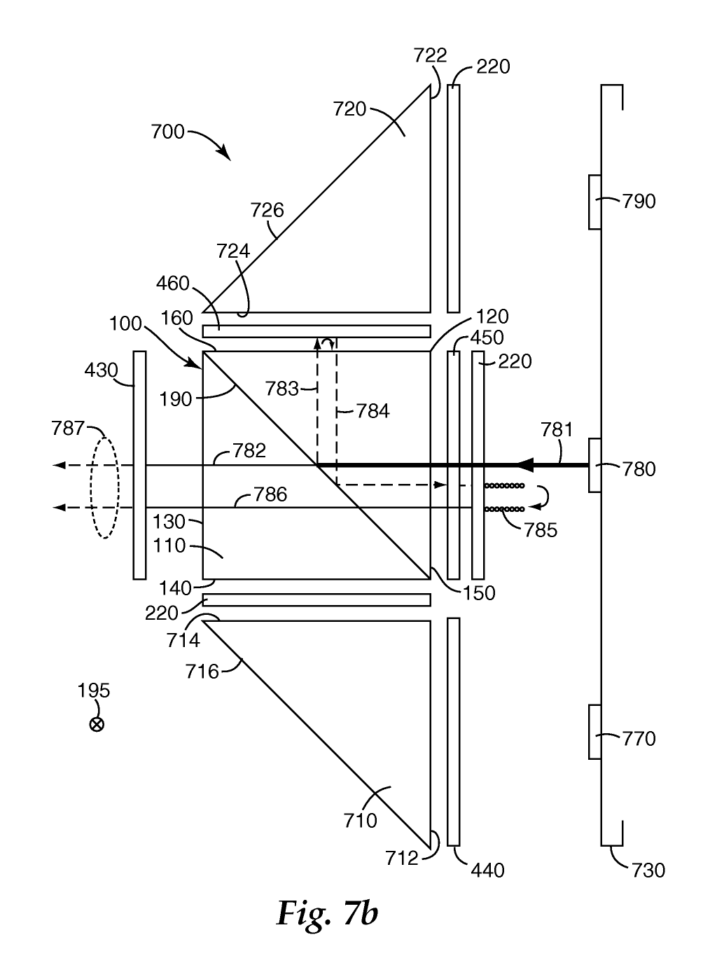

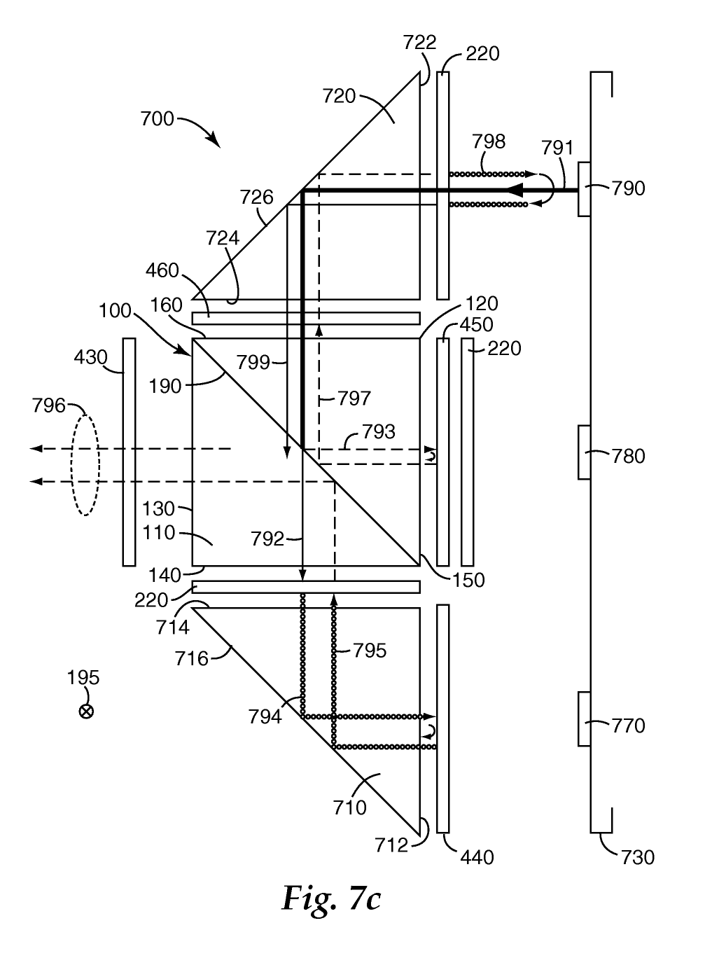

In one aspect, FIGS. 7a-7c are top schematic views of a color combiner according to another aspect of the description. In FIGS. 7a-7c, paths of a first through third light rays 771, 781, 791 are described through unfolded color combiner 700 that includes a PBS 100. Unfolded color combiner 700 can be one embodiment of light combiner 400 described with reference to FIGS. 4a-4c, and can be used with a variety of light sources as described elsewhere. The paths of light rays of each polarization emitted from a first, second, and third partially reflective light source 770, 780, 790 located on the plane 730, are shown in FIGS. 7a-7c, to more clearly illustrate the function of the various components of unfolded color combiner 700. In one embodiment, plane 730 can include a heat exchanger common to the three light sources.

Unfolded color combiner 700 includes a third prism 710 and a fourth prism 720 disposed facing second prism face 140 and fourth prism face 160, respectively, of PBS 100 (described elsewhere). Third prism 710 and fourth prism 720 are each a “turning prism”. First and third light 771, 791 emanating from first and third light sources 770, 790 located on plane 730 are turned by third and fourth prisms 710, 720 to enter PBS 100 in a direction perpendicular to second and fourth prism faces 140, 160, respectively.

Third prism 710 includes fifth and sixth prism faces, 712, 714, and diagonal prism face 916 between them. Fifth and sixth prism faces 712, 714 are “turning prism faces”. Fifth prism face 712 is positioned to receive first light 771 from first light source 770 and direct light to second prism face 140. Fourth prism 720 includes seventh and eighth prism faces 722, 724, and diagonal prism face 726 between them. Seventh and eighth prism faces 722, 724 also are “turning prism faces”. Seventh prism face 722 is positioned to receive third light 791 from third light source 790 and direct light to fourth prism face 160.

Fifth, sixth seventh and eighth prism faces 712, 714, 722, 724, and diagonal prism faces 716, 726 can be polished for preservation of TIR, as described elsewhere. Diagonal prism faces 716, 726 of third and fourth prisms 710, 720 can also include a metal coating, a dielectric coating, an organic or inorganic interference stack, or a combination to enhance reflection.

A first, second and third wavelength selective filter 440, 450, 460 is disposed facing the second, third and fourth prism faces 140, 150, 160, respectively. Each of the first, second and third wavelength selective filters 440, 450, 460 can be a dichroic filter selected to transmit a first, second and third wavelength spectrum of light and reflect other wavelength spectrums of light. As shown in FIG. 7a-7c, second and third wavelength selective filters 450, 460 are disposed facing and adjacent to third and fourth prism face 150, 160, respectively, while first wavelength selective filters is disposed facing but not adjacent to second prism face 140, as described elsewhere.

A retarder 220 is disposed facing each of the first, second and third wavelength selective filters 440, 450, 460. The retarder 220, wavelength selective filter (440, 450, 460), and partially reflective light source (770, 780, 790) cooperate to transmit one polarization direction of light, and recycle the other polarization state of light, as described elsewhere. In one embodiment, each retarder 220 in unfolded color combiner 700 is a quarter-wave retarder orientated at 45° to the first polarization direction 195.

In one embodiment shown in FIGS. 7a-7c, first wavelength selective filter 440 and the associated retarder 220 are disposed facing fifth and sixth prism faces 712, 714, respectively, and are also facing second prism face 140 of PBS 100. In one embodiment, third wavelength selective filter 460 and the associated retarder 220 are disposed facing eighth and seventh prism faces 724, 722, respectively, and are also facing fourth prism face 160 of PBS 100. In another embodiment (not shown), first wavelength selective filter 440 and associated retarder 220 are positioned facing one another in a manner similar to the positioning of second wavelength selective filter 450 and the associated retarder 220 (e.g. adjacent each other). In this case first wavelength selective filter 440 and retarder 220 can either be placed adjacent to fifth prism face 712, or adjacent to second prism face 140. In principle, unfolded light combiner 700 can function regardless of the separation between wavelength selective filters and associated retarders, provided the orientation of each relative to the path of the light rays is unchanged, i.e. each is substantially perpendicular to the path of the light ray. However, depending on the nature of the reflection from diagonal prism faces 716 and 726, there may be more or less polarization mixing introduced by the reflection from those faces. This polarization mixing may result in lost light efficiency, and can be minimized by placing the wavelength selective filters 440 and 460 closer to prism faces 140 and 160.

Each of the wavelength selective filters 440, 450, 460 can be separate from the associated quarter-wave retarder 220 as shown in FIG. 7a-7c. Further, each of the wavelength selective filters 440, 450, 460 can be in direct contact with the adjacent quarter-wave retarder 220. Alternatively, each of the wavelength selective filters 440, 450, 460 can be adhered to the adjacent quarter-wave retarder 220 with an optical adhesive. The optical adhesive can be a curable adhesive. The optical adhesive can also be a pressure-sensitive adhesive.

Unfolded light combiner 700 can be a two color combiner. In this embodiment, two of the wavelength selective filters 440, 450, 460 are a first and a second dichroic filter selected to transmit a first and a second color light respectively, and reflect other colors of light. The third reflector is a mirror. By mirror is meant a specular reflector selected to reflect substantially all colors of light. The first and second color light can have minimum overlap in the spectral range; however there can be substantial overlap if desired.

In one embodiment shown in FIGS. 7a-7c, unfolded light combiner 700 is a three color combiner. In this embodiment, wavelength selective filters 440, 450, 460 are first, second and a third dichroic filter selected to transmit the first, second, and a third color light respectively, and reflect other colors of light. In one aspect, the first, second and third color light have minimum overlap in the spectral range, however there can be substantial overlap, if desired. A method of using unfolded light combiner 700 of this embodiment includes directing a first light 771 having the first color toward first dichroic filter 440, directing a second light 781 having the second color toward second dichroic filter 450, directing a third light 791 having the third color toward third dichroic filter 460, and receiving combined light from the second face 130 of PBS 100. The path of each of the first, second and third light 771, 781, 791 are further described with reference to FIGS. 7a-7c.

In one embodiment, each of the first, second and third light 771, 781, 791 can be unpolarized light and the combined light is polarized. In a further embodiment, each of the first, second and third lights 771, 781, 791 can be red, green and blue unpolarized light, and the combined light can be polarized white light. Each of the first, second, and third lights 771, 781, 791 can comprise light as described elsewhere with reference to FIGS. 4a-4c.

In one aspect, unfolded light combiner 700 can include optional light tunnels 350 as described in FIG. 3b. The light tunnels 350 can be useful to partially collimate light originating from the light source, and decrease the angle that the light enters PBS 100. Light tunnels 350 are an optional component for the unfolded color combiner 700, and can also be optional components for any of the color combiners and splitters described herein. The light tunnels could have straight or curved sides, or they could be replaced by a lens system. Different approaches may be preferred depending on specific details of each application, and those with skill in the art will face no difficulty in selecting the optimal approach for a specific application.

Unfolded color combiner 700 also includes a filter 430 disposed facing the first prism face 130, the filter 430 capable of changing the polarization direction of at least one selected wavelength spectrum of light without changing the polarization direction of at least another selected wavelength spectrum of light. In one aspect, the filter 430 is a color-selective stacked retardation polarizer, such as a ColorSelect® filter (available from ColorLink® Inc., Boulder, Col.).

Each of the partially reflective light sources (770, 780, 790) has a surface that is at least partially light reflective. Each light source is mounted on a plane 730 that can also be at least partially reflective. The reflective light sources, and optionally the reflective plane, cooperate with the unfolded color combiner to recycle light and improve efficiency. According to yet another aspect, light tunnels or collection lenses can be provided to provide spacing that separate light sources from the polarizing beam splitter, as described elsewhere. An integrator can be provided at the output of the color combiner to increase uniformity of combined light outputs. According to one aspect, each partially reflective light source (770, 780, 790) comprises one or more light emitting diodes (LED's). Various light sources can be used such as lasers, laser diodes, organic LED's (OLED's), and non solid state light sources such as ultra high pressure (UHP), halogen or xenon lamps with appropriate collectors or reflectors. Light sources, light tunnels, lenses, and light integrators useful in the present invention are further described, for example, in copending U.S. Patent Application Ser. No. 60/938,834, the disclosure of which is herein included in its entirety.

The path of a first color light 771 will now be described with reference to FIG. 7a, where unpolarized first color light 771 exits unfolded color combiner 700 as s-polarized first color light 779. First light source 770 injects unpolarized first color light 771 through first dichroic filter 440, enters third prism 710 through fifth prism face 712, reflects from diagonal prism face 716 and exits third prism 710 through sixth prism face 714. Unpolarized first color light 771 passes through retarder 220, enters PBS 100 through second prism face 140, intercepts reflective polarizer 190, and is split into p-polarized first color light 772 and s-polarized first color light 773. S-polarized first color light 773 reflects from reflective polarizer 190, exits PBS 100 through first prism face 130 and passes unchanged through filter 430, becoming s-polarized first color light 779.

P-polarized first color light 772 is transmitted through reflective polarizer 190, exits PBS 100 through fourth prism face 160, reflects from third dichroic filter 460, and re-enters PBS 100 through fourth prism face 160 as p-polarized first color light 774. P-polarized first color light 774 passes through reflective polarizer 190, exits PBS 100 through second prism face 140, and changes to first direction circular polarized first color light 775 as it passes through retarder 220. First direction circular polarized first color light 775 enters third prism 710 through sixth prism face 714, reflects from diagonal prism face 716, changing to second direction circular polarized first color light, exits third prism 710 through fifth prism face 712, passes unchanged through first dichroic filter 440, reflects from partially reflective first light source 770, changing to first direction circular polarized first color light, and passes through dichroic filter 440. First direction circular polarized first color enters third prism 710 through fifth prism face 712, reflects from diagonal prism face 716, changing direction of circular polarization to second direction circular polarized first color light 776, and exits third prism 710 through sixth prism face 714. Second direction circular polarized first color light 776 passes through retarder 220 becoming s-polarized first color light 777 which enters PBS 100 through second face 140, reflects from reflective polarizer 190, exits PBS 100 through first prism face 130, and passes unchanged through filter 430, becoming s-polarized first color light 779.

The path of a second color light 781 will now be described with reference to FIG. 7b, where unpolarized second color light 781 exits unfolded color combiner 700 as s-polarized second color light 787. Second partially reflective light source 780 injects unpolarized second color light 781 through retarder 220 and second dichroic filter 450, enters PBS 100 through third prism face 150, intercepts reflective polarizer 190, and is split into p-polarized second color light 782 and s-polarized first color light 783. P-polarized second color light 782 passes unchanged through reflective polarizer 190, exits PBS 100 through first prism face 130 and passes through filter 430, changing polarization direction to become s-polarized second color light 787.

S-polarized second color light 783 reflects from reflective polarizer 190, exits PBS 100 through fourth prism face 160, reflects from third dichroic filter 460, and enters PBS 100 through fourth prism face 160 as s-polarized second color light 784. S-polarized second color light 784 reflects from reflective polarizer 190, exits PBS 100 through third prism face 150, passes through second dichroic filter 450, and changes to circular polarized second color light 785 as it passes through retarder 220. Circular polarized second color light 785 reflects from second partially reflective light source 780, changes direction of circular polarization, and passes through retarder 220, changing to p-polarized second color light 786. P-polarized second color light 786 passes through second dichroic filter 450, enters PBS 100 through third prism face 150, passes through reflective polarizer 190, exits PBS 100 through first prism face 130, and changes to s-polarized second color light 787 as it passes through filter 430.

The path of a third color light 791 will now be described with reference to FIG. 7c, where unpolarized third color light 791 exits unfolded color combiner 700 as s-polarized third color light 796. Third partially reflective light source 790 injects unpolarized third color light 791 through retarder 220, enters fourth prism 720 through seventh prism face 722, reflects from diagonal prism face 726, and exits fourth prism 720 through eighth prism face 724. Unpolarized third color light 791 passes through third dichroic filter 460, enters PBS 100 through fourth prism face 160, intercepts reflective polarizer 190, and is split into p-polarized third color light 792 and s-polarized third color light 793. P-polarized third color light 792 passes through reflective polarizer 190, exits PBS 100 through second prism face 140 and changes to first direction circular polarized second color light 794 as it passes through retarder 220. First direction circular polarized second color light 794 enters third prism 710 through sixth prism face 714, reflects from diagonal prism face 716, changing the direction of circular polarization to second direction circular polarized second color light, exits third prism 710 through fifth prism face 712, reflects from first dichroic filter 440, again changing direction of circular polarization to first direction circular polarized second color light, enters third prism 710 through fifth prism face 712, reflects from diagonal prism face 716, again changing direction of circular polarization to second direction circular polarized second color light 775. Second direction circular polarized second color light 775 exits third prism 710 through sixth prism face 714, and changes to s-polarized third color light 796 as it passes through retarder 220. S-polarized third color light 796 enters PBS 100 through second prism face 140, reflects from reflective polarizer 190, exits PBS 100 through first prism face 130 and passes unchanged through filter 430, becoming s-polarized third color light 796.

S-polarized third color light 793 reflects from reflective polarizer 190, exits PBS 100 through third prism face 150, reflects from second dichroic filter 450, and enters PBS 100 through third prism face 150 as s-polarized third color light 797. S-polarized third color light 797 reflects from reflective polarizer 190, exits PBS 100 through fourth prism face 160, passes through third dichroic filter 460, enters fourth prism 720 through eighth prism face 724, reflects from diagonal prism face 726 and exits fourth prism 720 through seventh prism face 722. S-polarized third color light 797 changes to circular polarized third color light 798 as it passes through retarder 220, then reflects from third partially reflective light source 790 changing direction of circular polarization, and changes to p-polarized third color light 799 as it passes through retarder 220. P-polarized third color light 799 enters fourth prism 720 through seventh prism face 722, reflects from diagonal prism face 726, exits fourth prism 720 through eighth prism face 724, passes through third dichroic filter 460, enters PBS 100 through fourth prism face 160, and passes through reflective polarizer 190. P-polarized third color light 799 then follows the same path through unfolded color combiner 700 as p-polarized third color light 792, described above, and exits unfolded color combiner 700 as s-polarized third color light 796.

In one embodiment, first color light 771 is blue light, second color light 781 is green light, and third color light 791 is red light. According to this embodiment, dichroic filter 440 is a red light reflecting and blue light transmitting dichroic filter, dichroic filter 450 is a red light reflecting and green light transmitting dichroic filter, and dichroic filter 460 is a green and blue light reflecting and red light transmitting dichroic filter. According to one embodiment, filter 430 is a GM ColorSelect® filter that changes the polarization direction of green light while allowing both red and blue light to be transmitted without change in polarization. According to another embodiment, filter 430 is an MG ColorSelect® filter that changes the polarization direction of red and blue light while allowing green light to be transmitted without change in polarization.

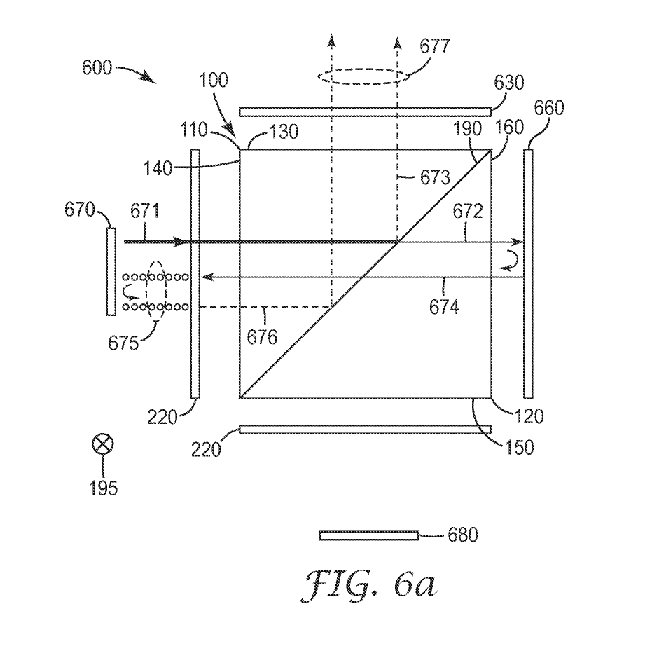

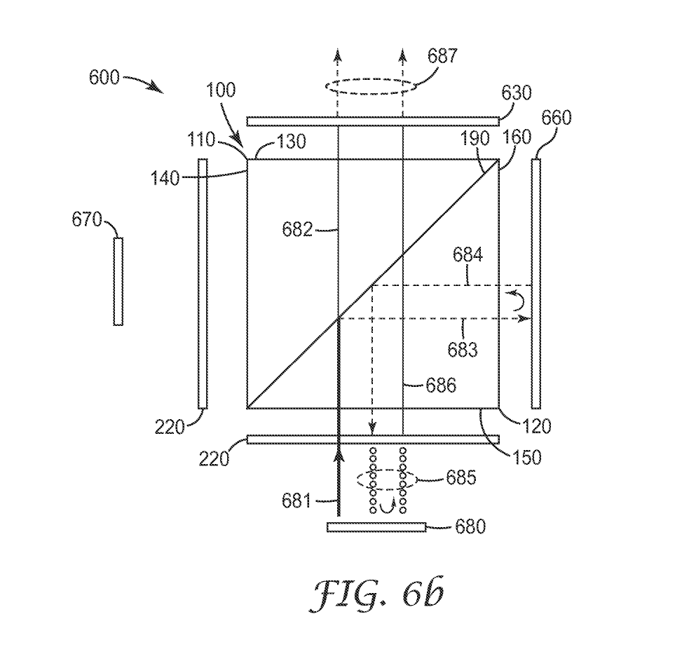

In one aspect, FIGS. 6a-6b are top view schematic representations of a light combiner 600 that includes a PBS 100. Color combiner 600 can be used with a variety of light sources as described elsewhere. In one embodiment, FIGS. 6a-6b shows two or more colors (e.g. red and blue) included in a first partially reflective light source 670, and a second partially reflective light source 680 including a third color (e.g. green), which are combined in the color combiner 600. In this embodiment, color combiner 600 eliminates some components that appear in other embodiments, since it may not require the use of dichroic filters positioned within the light paths.

The paths of light rays of each polarization emitted from the first and second light source 670, 680 are shown in FIGS. 6a-6b, to more clearly illustrate the function of the various components of color combiner 600. PBS 100 includes a reflective polarizer 190 aligned to the first polarization direction 195 as described elsewhere. In one aspect, the reflective polarizer 190 can comprise a polymeric multilayer optical film. A first and second retarder 220 is disposed facing the second and third prism faces 140, 150, respectively. A mirror 660 is disposed facing the fourth prism face 160.

The retarder 220, mirror 660, and partially reflective light source (670, 680) cooperate to transmit one polarization direction of light, and recycle the other polarization state of light, as described elsewhere. In one embodiment, each retarder 220 in color combiner 600 is a quarter-wave retarder orientated at 45° to the first polarization direction 195.

Color combiner 600 also includes a filter 630 disposed facing the first prism face 130, the filter 630 capable of changing the polarization direction of at least one selected wavelength spectrum of light without changing the polarization direction of at least another selected wavelength spectrum of light. In one aspect, the filter 630 is a color-selective stacked retardation polarizer, such as a ColorSelect® filter (available from ColorLink® Inc., Boulder, Col.).

Each of the partially reflective light sources (670, 680) has a surface that is at least partially light reflective. Each light source is mounted on a substrate that can also be at least partially reflective. The reflective light source, and optionally the reflective substrate cooperate with the color combiner to recycle light and improve efficiency. According to yet another aspect, light tunnels or lenses can be provided to provide spacing that separate light sources from the polarizing beam splitter as described elsewhere. An integrator can be provided at the output of the light combiner to increase uniformity of combined light outputs. According to one aspect, each partially reflective light source (670, 680) comprises one or more light emitting diodes (LED's). Various light sources can be used such as lasers, laser diodes, organic LED's (OLED's), and non solid state light sources such as ultra high pressure (UHP), halogen or xenon lamps with appropriate collectors or reflectors. Light sources, light tunnels, and light integrators useful in the present invention are further described, for example, in copending U.S. Patent Application Ser. No. 60/938,834, the disclosure of which is herein included in its entirety.

The path of light from the first partially reflective light source 670 will now be described with reference to FIG. 6a, where unpolarized first light 671 exits color combiner 600 as s-polarized first light 677. It is to be understood that first partially reflective light source 670 can include a first color light and a second color light, and the path for each of these color lights will be the same through color combiner 600. First partially reflective light source 670 injects first light 671 through retarder 220, enters PBS 100 through second prism face 140, and intercepts reflective polarizer 190 where it is split into p-polarized first light 672 and s-polarized first light 673. S-polarized first light 673 reflects from reflective polarizer 190, exits PBS 100 through first prism face 130 and passes unchanged through filter 630 as s-polarized first light 677.

P-polarized first light 672 passes through reflective polarizer 190, exits PBS 100 through fourth prism face 160, reflects unchanged from mirror 660, and enters PBS 100 through fourth prism face 160 as p-polarized first light 674. P-polarized first light 674 passes through reflective polarizer 190, exits PBS 100 through second prism face 140, changes to circular polarized first light 675 as it passes through retarder 220, reflects from partially reflective first light source 670 changing the direction of circular polarization, and changes to s-polarized first light 676 as it passes through retarder 220. S-polarized first light 676 enters PBS 100 through second prism face, reflects from reflective polarizer 190, exits PBS 100 through first prism face 130 and passes unchanged through filter 630 as s-polarized first light 677.

The path of light from the second partially reflective light source 680 will now be described with reference to FIG. 6b, where unpolarized second light 681 exits color combiner 600 as s-polarized second light 687. Second partially reflective light source 680 injects second light 681 through retarder 220, enters PBS 100 through third prism face 150, and intercepts reflective polarizer 190 where it is split into p-polarized second light 682 and s-polarized second light 683. P-polarized second light 682 passes through reflective polarizer 190, exits PBS 100 through first prism face 130, and changes to s-polarized second light 687 as passes through filter 630.

S-polarized second light 683 reflects from reflective polarizer 190, exits PBS 100 through fourth prism face 160, reflects unchanged from mirror 660, and enters PBS 100 through fourth prism face 160 as s-polarized second light 684. S-polarized second light 684 reflects from reflective polarizer 190, exits PBS 100 through third prism face 150, changes to circular polarized second light 685 as it passes through retarder 220, reflects from second partially reflective light source 680 changing the direction of circular polarization, and changes to p-polarized second light 686 as it passes through retarder 220. P-polarized second light 686 enters PBS 100 through third prism face 150, passes through reflective polarizer 190, exits PBS 100 through first prism face 130 and changes to s-polarized second light 677 as it passes through filter 630.

In one embodiment, first light 671 comprises a blue color light and a red color light in the same package, for example those available from Osram Opto Semiconductors under the designation OSTAR® SMP series LED. In this embodiment, second color light 681 is a green color light. According to one embodiment, filter 630 is a GM ColorSelect® filter that changes the polarization direction of green light while allowing both red and blue light to be transmitted without change in polarization. According to another embodiment, filter 630 is an MG ColorSelect® filter that changes the polarization direction of red and blue light while allowing green light to be transmitted without change in polarization.

Light sources in a three color light combining system can be energized sequentially, as described in co-pending U.S. Patent Application Ser. No. 60/638834. According to one aspect, the time sequence is synchronized with a transmissive or reflective imaging device in a projection system that receives a combined light output from the three color light combining system. According to one aspect, the time sequence is repeated at rate that is fast enough so that an appearance of flickering of projected image is avoided, and appearances of motion artifacts such as color break up in a projected video image are avoided.

FIG. 5 illustrates a projector 500 that includes a three color light combining system 502. The three color light combining system 502 provides a combined light output at output region 504. In one embodiment, combined light output at output region 504 is polarized. The combined light output at output region 504 passes through light engine optics 506 to projector optics 508.

The light engine optics 506 comprise lenses 522, 524 and a reflector 526. The projector optics 508 comprise a lens 528, a beam splitter 530 and projection lenses 532. One or more of the projection lenses 532 can be movable relative to the beam splitter 530 to provide focus adjustment for a projected image 512. A reflective imaging device 510 modulates the polarization state of the light in the projector optics, so that the intensity of the light passing through the PBS and into the projection lens will be modulated to produce the projected image 512. A control circuit 514 is coupled to the reflective imaging device 510 and to light sources 516, 518 and 520 to synchronize the operation of the reflective imaging device 510 with sequencing of the light sources 516, 518 and 520. In one aspect, a first portion of the combined light at output region 504 is directed through the projector optics 508, and a second portion of the combined light output is recycled back into color combiner 502 through output region 504. The second portion of the combined light can be recycled back into color combiner by reflection from, for example: a mirror, a reflective polarizer, a reflective LCD and the like. The arrangement illustrated in FIG. 5 is exemplary, and the light combining systems disclosed can be used with other projection systems as well. According to one alternative aspect, a transmissive imaging device can be used.

According to one aspect, a color light combining system as described above produces a three color (white) output. The system has high efficiency because polarization properties (reflection for S-polarized light and transmission for P-polarized light) of a polarizing beam splitter with reflective polarizer film have low sensitivity for a wide range of angles of incidence of source light. Additional collimation components can be used to improve collimation of the light from light sources in the color combiner. Without a certain degree of collimation, there will be significant light losses associated with variation of dichroic reflectivity as a function of angle of incidence (AOI), loss of TIR or increased evanescent coupling to frustrate the TIR, and/or degraded polarization discrimination and function in the PBS. In the present disclosure, polarizing beam splitters function as light pipes to keep light contained by total internal reflection, and released only through desired surfaces.

Although the present invention has been described with reference to preferred embodiments, workers skilled in the art will recognize that changes may be made in form and detail without departing from the spirit and scope of the invention.

1-43. (canceled)

44. A color combiner, comprising:
a first dichroic filter
a second dichroic filter disposed approximately orthogonal to the first dichroic filter;
a third dichroic filter disposed facing the first dichroic filter and approximately orthogonal to the second dichroic filter;
a color-selective polarization rotating filter disposed facing the second dichroic filter and approximately orthogonal to both the first dichroic filter and the third dichroic filter;
a reflective polarizer disposed between the first and third dichroic filters so that a normal from each of the first, second, and third dichroic filters intersects the reflective polarizer at approximately 45 degrees; and
a first, second and third retarder disposed adjacent each of the first, second and third dichroic filters, respectively.

45. The color combiner of claim 44, wherein the reflective polarizer is aligned to a first polarization direction.

46. The color combiner of claim 44, wherein the first, second and third retarder are quarter-wave retarders aligned at approximately 45 degrees to a first polarization direction.

47. The color combiner of claim 45, wherein the reflective polarizer is a Cartesian reflective polarizer.

48. The color combiner of claim 47, wherein the Cartesian reflective polarizer is a polymeric multilayer optical film.

49. The color combiner of claim 44, wherein the color-selective polarization rotating filter comprises a color-selective stacked retardation polarization filter.

50. The color combiner of claim 44, wherein the first retarder is disposed between the first dichroic filter and the reflective polarizer, the second dichroic filter is disposed between the second retarder and the reflective polarizer, and the third dichroic filter is disposed between the third retarder and the reflective polarizer.

51. The color combiner of claim 44, further comprising:
a first unpolarized light source with an emitting surface that is at least partially reflective and capable of emitting light toward the first, second or third dichroic filter,
wherein the reflective emitting surface, respective retarder, and dichroic filter cooperate to recycle light from the first unpolarized light source.

52. The color combiner of claim 51, wherein the unpolarized light source is an LED comprising a first color of light.

53. (canceled)

54. A method of combining light, comprising:
providing the color combiner of claim 44;
directing unpolarized light of a first, a second and a third color toward the first, second and third dichroic filters, respectively; and
receiving a combined polarized light from the color-selective polarization rotating filter.

55. (canceled)

56. The method of claim 54, wherein the first, second, third colors are blue, green and red, respectively, and the combined light is white light.

57-70. (canceled)

71. The light combiner of claim 26, further comprising at least one turning prism having a diagonal face and a turning prism face, wherein the turning prism face is disposed facing one of the first, second or third retarders.
